(19) United States
(12) Patent Application Publication
(10) Pub. No.: US 2025/0115258 A1
(43) Pub. Date: Apr. 10, 2025

(54) IN-VEHICLE SYSTEM, IN-VEHICLE DEVICE, AND SOFTWARE SWITCHING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shota USHIRO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/688,662

(22) PCT Filed: Jun. 28, 2022
(86) PCT No.: PCT/JP2022/025841

§ 371 Date: Mar. 1, 2024

(30) Foreign Application Priority Data
Sep. 7, 2021 (JP) 2021-145815

(51) Int. Cl. B60W 50/023; B60W 50/06

(52) U.S. Cl. CPC B60W 50/023; B60W 50/06

(57) ABSTRACT

An in-vehicle device to be installed in a vehicle includes: a memory for storing first software for providing a user with first information; a determination unit configured to determine whether or not to switch software to be executed from the first software to second software for providing the user with second information that is more detailed than the first information, based on status information regarding status of the vehicle; a request unit configured to make a request for download of the second software to the external device disposed outside the vehicle if the determination unit determines that the software to be executed is switched from the first software to the second software; and a switching unit configured to install, in the memory, the second software downloaded from the external device, and switch the software to be executed from the first software to the second software.

### CROSS-REFERENCE TO RELATED APPLICATIONS

This application is the U.S. national stage of PCT/JP2022/025841 filed on Jun. 28, 2022, which claims priority of Japanese Patent Application No. JP 2021-145815 filed on Sep. 7, 2021, the contents of which are incorporated herein.

### TECHNICAL FIELD

The present disclosure relates to an in-vehicle system, an in-vehicle device, and a software switching method.

### BACKGROUND

Software is incorporated in an in-vehicle device installed in a vehicle, and the in-vehicle device realizes a specific function by executing the software (e.g. JP 2020-062909A).

As software becomes more functional, a variety of information can be provided to the user, while the size of the software increases. The capacity of memories (ROM: Read Only Memory, RAM: Random Access Memory) installed in an in-vehicle device is limited, and the larger the software size is, the more the capacity of the memories is squeezed. Furthermore, an increase in the size of software leads to an increase in the memory capacity.

### SUMMARY

An in-vehicle system according to one aspect of the present disclosure includes: a first in-vehicle device; a second in-vehicle device capable of communicating with the first in-vehicle device; and an external communication device capable of communicating with an external device disposed outside a vehicle, the first in-vehicle device including: a memory for storing first software for providing a user with first information; a determination unit configured to determine whether or not to switch software to be executed from the first software to second software for providing the user with second information that is more detailed than the first information, based on status information regarding status of the vehicle; a request unit configured to make a request for download of the second software to the external device via the external communication device if the determination unit determines that the software to be executed is switched from the first software to the second software; and a switching unit configured to install, in the memory, the second software downloaded from the external device, and switch the software to be executed from the first software to the second software.

An in-vehicle device according to one aspect of the present disclosure is an in-vehicle device to be installed in a vehicle, and includes: a memory for storing first software for providing a user with first information; a determination unit configured to determine whether or not to switch software to be executed from the first software to second software for providing the user with second information that is more detailed than the first information, based on status information regarding status of the vehicle; a request unit configured to make a request for download of the second software to the external device disposed outside the vehicle if the determination unit determines that the software to be executed is switched from the first software to the second software; and a switching unit configured to install, in the memory, the second software downloaded from the external device, and switch the software to be executed from the first software to the second software.

A software switching method according to one aspect of the present disclosure is a software switching method for switching software incorporated in an in-vehicle device to be installed in a vehicle, and includes: a step of determining whether or not to switch software to be executed from first software for providing a user with first information to second software for providing the user with second information that is more detailed than the first information, based on status information regarding status of the vehicle; a step of making a request for download of the second software to the external device disposed outside the vehicle if it is determined that the software to be executed is switched from the first software to the second software; and a step of installing, in a memory included in the in-vehicle device, the second software downloaded from the external device, and switching the software to be executed from the first software to the second software.

The present disclosure can be realized as not only an in-vehicle device having the above-described characteristic configuration, a software switching method having steps corresponding to characteristic processing performed in the in-vehicle device, and an in-vehicle system that includes the in-vehicle device, but also a program for causing the in-vehicle device to execute the characteristic processing. Furthermore, a part or all of the in-vehicle device can also be realized as a semiconductor integrated circuit.

According to the present disclosure, it is possible to provide the user with a variety of information while preventing an increase in the capacity of the memories installed in the in-vehicle device.

### BRIEF DESCRIPTION OF DRAWINGS

FIG. 1 is a schematic diagram for illustrating an example of a communication system according to an embodiment.

FIG. 2 is a block diagram showing an example of a configuration of an in-vehicle system according to the embodiment.

FIG. 3 is a block diagram showing an example of a configuration of an integrated ECU according to the embodiment.

FIG. 4 is a block diagram showing an example of a configuration of an individual ECU according to the embodiment.

FIG. 5 is a functional block diagram showing an example of functionality of the integrated ECU according to the embodiment.

FIG. 6 shows an example of a priority table.

FIG. 7 shows an example of a display screen of simplified software.

FIG. 8 shows an example of a display screen of detailed software.

FIG. 9 shows another example of a display screen of simplified software.

FIG. 10 shows another example of a display screen of detailed software.

FIG. 11 is a flowchart showing an example of data collection processing performed by the individual ECU according to the embodiment.

FIG. 12 is a flowchart showing an example of software switching determination processing performed by the integrated ECU according to the embodiment.

FIG. 13 is a flowchart showing an example of software switching processing performed by the integrated ECU according to the embodiment.

### DETAILED DESCRIPTION OF PREFERRED EMBODIMENTS

The summary of an embodiment of the present disclosure will be listed and described below.

An in-vehicle system according to the present embodiment includes: a first in-vehicle device; a second in-vehicle device capable of communicating with the first in-vehicle device; and an external communication device capable of communicating with an external device disposed outside a vehicle, the first in-vehicle device including: a memory for storing first software for providing a user with first information; a determination unit configured to determine whether or not to switch software to be executed from the first software to second software for providing the user with second information that is more detailed than the first information, based on status information regarding status of the vehicle; a request unit configured to make a request for download of the second software to the external device via the external communication device if the determination unit determines that the software to be executed is switched from the first software to the second software; and a switching unit configured to install, in the memory, the second software downloaded from the external device, and switch the software to be executed from the first software to the second software. The first software is used to provide the user with simple information. Thus, the capacity of the memory of the first in-vehicle device can be prevented from being squeezed. It is therefore possible to prevent an increase in the capacity of the memory installed in the first in-vehicle device. When providing the user with detailed information, the software to be executed is switched from the first software to the second software. Accordingly, a variety of information can be provided to the user.

The second in-vehicle device may include a sensor configured to detect status of hardware installed in the vehicle, and the status information may include information regarding the status of the hardware detected by the sensor. It can be determined, using the information acquired by the sensor, whether or not to switch the software to be executed from the first software to the second software. With this configuration, the second software for providing the user with detailed information for replacing or repairing the hardware can be executed if, for example, it is determined that the hardware needs to be replaced or repaired based on the status of the hardware detected by sensor.

The status information may include information regarding predicted future usage status of hardware installed in the vehicle. It can be determined whether or not to switch the software to be executed from the first software to the second software while considering the future usage status of the hardware installed in the vehicle. With this configuration, the second software for providing the user with detailed information for replacing or repairing the hardware can be executed if, for example, it is determined that the hardware needs to be replaced or repaired based on the predicted future usage status of the hardware.

The status information may include information regarding environmental status around the vehicle. It can be determined whether or not to switch the software to be executed from the first software to the second software while considering the environmental status around the vehicle. With this configuration, the second software for providing the user with detailed information for replacing or repairing the hardware can be executed if, for example, it is determined that the hardware needs to be replaced or repaired based on the environmental status around the vehicle.

The determination unit may determine whether or not to switch the software to be executed from the first software to the second software, based on a priority assigned to the environmental status around the vehicle. For example, the software to be executed can be switched from the first software to the second software if the priority is higher than a reference.

The determination unit may determine that the software to be executed is switched from the first software to the second software if the user gives the determination unit an instruction to switch the software to be executed from the first software to the second software. With this configuration, the software to be executed can be switched from the first software to the second software in accordance with the instruction from the user.

The determination unit may determine whether or not to switch the software to be executed from the first software to the second software, based on a priority assigned to the second software. The priority may be assigned to the second software in accordance with the importance of information provided to the user by the second software. For example, the software to be executed can be switched from the first software to the second software if the priority is higher than the reference.

A plurality of the priorities may be each associated with a type of the second software and a type of environmental status around the vehicle. For example, the priority can be determined in accordance with the importance of the information provided to the user by the second software and the severity of the environmental status around the vehicle.

The status information may include information regarding communication status of the external communication device. For example, the second software can be downloaded if the communication status of the external communication device is good, and download of the second software can be avoided if the communication status of the external communication device is poor.

The first information may be text information, and the second information may include image information. The size of the first software can be made small by using simple text information as the first information. Detailed information in the form of images can be provided to the user by including image information in the second information.

The first information may be text information, and the second information may include sound information. The size of the first software can be made small by using simple text information as the first information. Detailed information in the form of sound can be provided to the user by including sound information in the second information.

The first information may be information indicating an abnormality of hardware installed in the vehicle, and the second information may include the information indicating the abnormality of the hardware installed in the vehicle and information indicating a countermeasure against the abnormality. When the hardware is abnormal, the first software can notify the user of the abnormality. Further, the size of the first software can be made small. The second software can not only notify the user of the abnormality, but also present a countermeasure against the abnormality to the user.

An in-vehicle device according to the present embodiment is an in-vehicle device to be installed in a vehicle, and includes: a memory for storing first software for providing a user with first information; a determination unit configured to determine whether or not to switch software to be executed from the first software to second software for providing the user with second information that is more detailed than the first information, based on status information regarding status of the vehicle; a request unit configured to make a request for download of the second software to the external device disposed outside the vehicle if the determination unit determines that the software to be executed is switched from the first software to the second software; and a switching unit configured to install, in the memory, the second software downloaded from the external device, and switch the software to be executed from the first software to the second software. The first software is used to provide the user with simple information. Thus, the capacity of the memory of the first in-vehicle device can be prevented from being squeezed. It is therefore possible to prevent an increase in the capacity of the memory installed in the first in-vehicle device. When providing the user with detailed information, the software to be executed is switched from the first software to the second software. Accordingly, a variety of information can be provided to the user.

A software switching method according to the present embodiment is a software switching method for switching software incorporated in an in-vehicle device to be installed in a vehicle, and includes: a step of determining whether or not to switch software to be executed from first software for providing a user with first information to second software for providing the user with second information that is more detailed than the first information, based on status information regarding status of the vehicle; a step of making a request for download of the second software to the external device disposed outside the vehicle if it is determined that the software to be executed is switched from the first software to the second software; and a step of installing, in a memory included in the in-vehicle device, the second software downloaded from the external device, and switching the software to be executed from the first software to the second software. The first software is used to provide the user with simple information. Thus, the capacity of the memory of the first in-vehicle device can be prevented from being squeezed. It is therefore possible to prevent an increase in the capacity of the memory installed in the first in-vehicle device. When providing the user with detailed information, the software to be executed is switched from the first software to the second software. Accordingly, a variety of information can be provided to the user.

Details of an embodiment of the present disclosure will be described below with reference to the drawings. Note that at least a part of the following embodiment may optionally be combined with other parts.

### Communication System

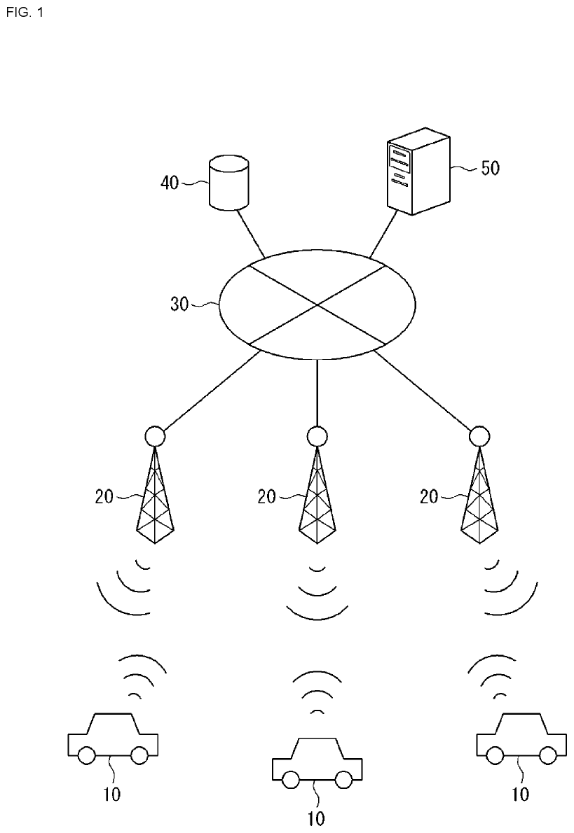

FIG. 1 is a schematic diagram for illustrating an example of a communication system according to the present embodiment.

The communication system is a system for providing occupants (users) of vehicles 10 with information regarding the vehicles. The communication system includes the vehicles 10, a database 40, and a server 50. Each vehicle 10 has a later-described in-vehicle system.

Each vehicle 10 can communicate wirelessly with devices outside the vehicle. The vehicle 10 is equipped with a wireless communication terminal that is compliant with, for example, the fifth-generation mobile communication system (5G) or the fourth-generation mobile communication system (4G), and can wirelessly communicate with base stations 20. Each base station 20 is connected to the Internet 30. The database 40 and the server 50 are also connected to the Internet 30. This configuration allows the vehicle 10 and the database 40 to communicate with each other, and enables the vehicle 10 and the server 50 to communicate with each other.

Installation data of detailed software for providing the user with detailed information regarding the vehicle 10 is stored in the database 40. The database 40 can transmit the installation data of the detailed software to the vehicle 10. The database 40 is an example of an “external device”. The detailed software is an example of “second software”.

The server 50 can transmit, to the vehicle 10, information that is used to determine whether or not to switch software to be executed from simplified software to the detailed software. The simplified software refers to software for providing the user with simplified information regarding the vehicle 10. The simplified software is an example of “first software”. The server 50 can transmit, to the vehicle 10, for example, meteorological information indicating current meteorological status, meteorological forecast information indicating future meteorological status, and road status information indicating road status.

### In-Vehicle System

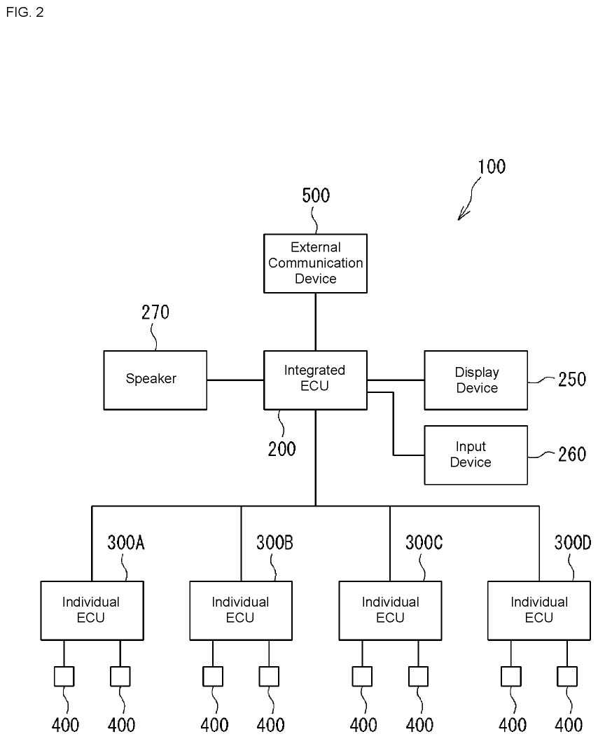

FIG. 2 is a block diagram showing an example of a configuration of an in-vehicle system according to the present embodiment.

An in-vehicle system 100 according to the present embodiment includes an integrated ECU 200 and individual ECUs 300A, 300B, 300C, and 300D. The integrated ECU 200 and the individual ECUs 300A, 300B, 300C, and 300D are connected by communication cables.

The integrated ECU 200 controls the entire vehicle 10 and provides the user with information regarding the vehicle 10. The integrated ECU 200 can execute the simplified software or the detailed software. The integrated ECU 200 is an example of a second in-vehicle device.

The plurality of individual ECUs 300A, 300B, 300C, and 300D are disposed at respective portions of the vehicle 10. The individual ECUs 300A, 300B, 300C, and 300D individually control hardware at the respective portions of the vehicle 10, and monitor the status of the hardware at the respective portions of the vehicle 10. For example, the individual ECU 300A is a device for monitoring the status of tires. The individual ECU 300B is a device for controlling a braking device and monitoring the status of the braking device. The individual ECU 300C is a device for controlling doors and monitoring the status of the doors. The individual ECU 300D is a device for controlling a battery for driving the vehicle, and monitoring the status of the battery. In the following description, the individual ECUs 300A, 300B, 300C, and 300D are also collectively referred to as “individual ECU(s) 300”.

The integrated ECU 200 is connected to the individual ECUs 300A, 300B, 300C, and 300D via an in-vehicle bus, such as a CAN (Controller Area Network) bus. The integrated ECU 200 can communicate with the individual ECUs 300A, 300B, 300C, and 300D. Each individual ECU 300 is an example of a first in-vehicle device.

The integrated ECU 200 is connected to a display device 250. The display device 250 includes, for example, a liquid crystal panel or an OEL (Organic ElectroLuminescent) panel. The display device 250 can display text or image information. The integrated ECU 200 can cause the display device 250 to display information (text information, image information) by controlling the display device 250.

The integrated ECU 200 is connected to an input device 260. The input device 260 includes, for example, a capacitive or pressure-sensitive touchpad that is laid over the display device 250. The user can input information to the integrated ECU 200 by operating the input device 260.

The integrated ECU 200 is connected to a speaker 270. The speaker 270 can output sound. The integrated ECU 200 can cause the speaker 270 to output sound information by controlling the speaker 270.

The integrated ECU 200 is connected to an external communication device 500. The external communication device 500 is, for example, a 5G- or 4G-compliant wireless communication terminal. The external communication device 500 can communicate with the database 40 and the server 50. The external communication device 500 relays communication between the integrated ECU 200, the database 40, and the server 50.

Sensors 400 are connected to the individual ECUs 300A, 300B, 300C, and 300D. Each sensor 400 detects the status of hardware of the vehicle 10. The sensor 400 outputs data (hereinafter referred to as “sensor data”) indicating a detection value. For example, the sensors 400 connected to the individual ECU 300A include an air pressure sensor that measures the air pressure of each tire, and a temperature sensor that measures the temperature of the tire. For example, the sensors 400 connected to the individual ECU 300A may also include a wear degree sensor that detects the wear degree of each tire. For example, the sensors 400 connected to the individual ECU 300B include a wear degree sensor that detects the wear degree of each brake pad. For example, the sensors 400 connected to the individual ECU 300C include a sensor that detects an open or closed state of each door. For example, the sensors 400 connected to the individual ECU 300D include a voltage sensor that measures the voltage of the battery, and a temperature sensor that detects the temperature of the battery. The individual ECUs 300A, 300B, 300C, and 300D can transmit the sensor data output from the sensors 400 to the integrated ECU 200.

The individual ECUs 300A, 300B, 300C, 300D may also be connected to actuators for operating the hardware. For example, the individual ECU 300B may also be connected to a motor for operating the braking device. For example, the individual ECU 300C may also be connected to a motor for opening and closing each door.

### Configuration of Integrated ECU

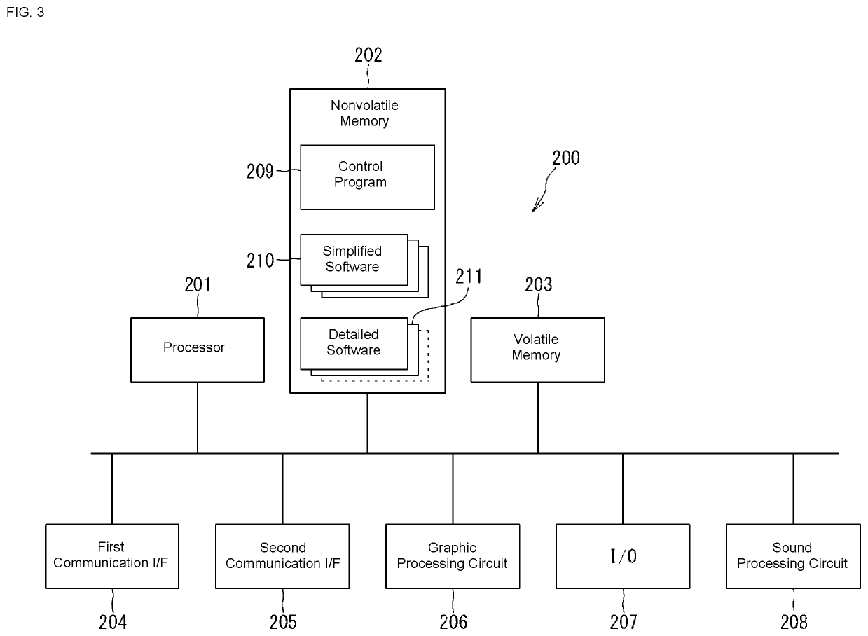

FIG. 3 is a block diagram showing an example of a configuration of the integrated ECU according to the present embodiment. The integrated ECU 200 includes a processor 201, a nonvolatile memory 202, a volatile memory 203, a first communication interface (I/F) 204, a second communication I/F 205, a graphic processing circuit 206, an input/output unit 207, and a sound processing circuit 208.

The volatile memory 203 is, for example, a semiconductor memory such as an SRAM (Static Random Access Memory) or a DRAM (Dynamic Random Access Memory). The nonvolatile memory 202 is, for example, a flash memory, a hard disk, a ROM (Read Only Memory), or the like. A control program 209 and simplified software 210, which are computer programs, and data used to execute the software are stored in the nonvolatile memory 202. Installation data of detailed software 211 downloaded from the database 40 allows the integrated ECU 200 to install the detailed software 211 in the nonvolatile memory 202. The integrated ECU 200 includes a computer, and exhibits each function thereof by executing the control program 209, the simplified software 210, and the detailed software 211, which are computer programs stored in a storage device of the computer.

The software (control program 209, simplified software 210, detailed software 211) includes program modules, for example. A program module is a software component for realizing a partial function of the software. The software is configured by combining a plurality of program modules.

The simplified software 210 is installed in the nonvolatile memory 202 in advance. That is, the simplified software 210 is installed in the nonvolatile memory 202 in the initial state. A plurality of types of the simplified software 210 are installed in the nonvolatile memory 202. For example, the plurality of types of the simplified software 210 include software for notifying the user of an abnormal air pressure of a tire, and software for notifying the user that a cold-region function (e.g. window deicer) of the vehicle 10 has turned on. The types of the simplified software 210 are not limited to the above, and may also include software for notifying the user of information other than the above.

The detailed software 211 is not installed in the nonvolatile memory 202 in the initial state. That is, the detailed software 211 is software that is additionally installed in the nonvolatile memory 202. Installation data of a plurality of types of the detailed software 211 are stored in the database 40. The integrated ECU 200 can download installation data of a specific type of the detailed software 211 (a type of the detailed software 211 requested by the integrated ECU 200) from the database 40, and install this type of the detailed software 211 in the nonvolatile memory 202.

The control program 209 is software for determining whether or not to switch software to be executed from the simplified software 210 to the detailed software 211. The integrated ECU 200 can execute later-described software switching determination processing as a result of the processor 201 executing the control program 209. The control program 209 manages installation of the detailed software 211. That is, the control program 209 is for downloading installation data of the detailed software 211 from the database 40, and installing the detailed software 211 in the nonvolatile memory 202 using the installation data. The control program 209 is for switching the software to be executed from the simplified software 210 to the detailed software 211 if the detailed software 211 is installed.

The processor 201 is, for example, a CPU (Central Processing Unit). However, the processor 201 is not limited to a CPU. The processor 201 may alternatively be a GPU (Graphics Processing Unit). The processor 201 can execute computer programs. Note that the processor 201 may include, as a part thereof, an ASIC (Application Specific Integrated Circuit) or a programmable logic device such as a gate array or an FPGA (field Programmable Gate Array), for example.

Each of the first communication I/F 204 and the second communication I/F 205 is, for example, a CAN interface. The first communication I/F 204 is connected to the individual ECUs 300A, 300B, 300C, and 300D via a communication bus. The integrated ECU 200 can communicate with the individual ECUs 300A, 300B, 300C, and 300D through the first communication I/F 204.

The second communication I/F 205 is connected to the external communication device 500 via a communication bus. The integrated ECU 200 can communicate with the external communication device 500 through the second communication I/F 205.

The graphic processing circuit 206 is connected to the display device 250 and controls display on the display device 250. The graphic processing circuit 206 includes, for example, a GPU and a VRAM (Video RAM). The graphic processing circuit 206 holds the data to be displayed on the display device 250 in the VRAM, periodically reads one frame worth of video data from the VRAM, and generates a video signal. The generated video signal is output to the display device 250, and a video is displayed on the display device 250. The functions of the graphic processing circuit 206 may be included in the processor 201. A partial area of the volatile memory 203 may be used as the VRAM.

The input/output unit (I/O) 207 is connected to the input device 260. Information provided to the input device 260 by the user is provided to the processor 201 through the I/O 207. The sound processing circuit 208 is connected to the speaker 270 and controls the sound output from the speaker 270.

### Configuration of Individual ECU

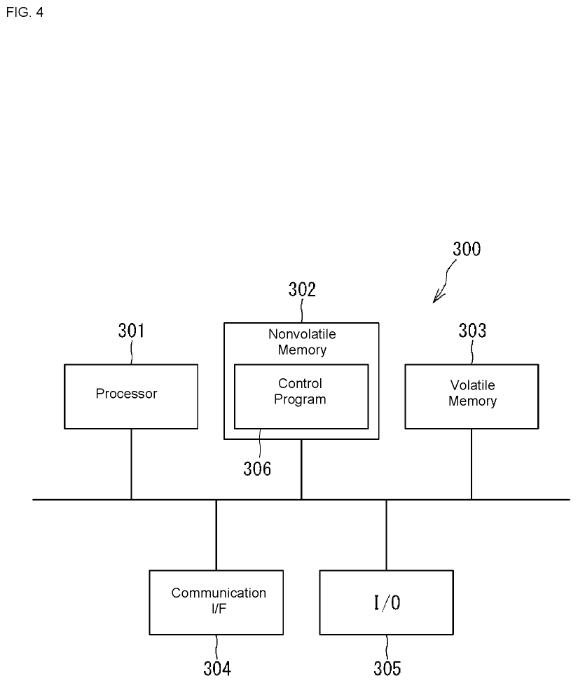

FIG. 4 is a block diagram showing an example of a configuration of the individual ECU according to the present embodiment. The individual ECU 300 includes a processor 301, a nonvolatile memory 302, a volatile memory 303, a communication I/F 304, and an input/output I/F (I/O) 305.

The volatile memory 303 is, for example, a semiconductor memory such as a SRAM or a DRAM. The nonvolatile memory 302 is, for example, a flash memory, a hard disk, a ROM, or the like. A control program 306, which is a computer program, and data used to execute the control program 306 are stored in the nonvolatile memory 302. The individual ECU 300 includes a computer, and each function of the individual ECU 300 is exhibited by executing the control program 306 that is a computer program stored in a storage device of the computer.

The control program 306 is software for monitoring the status of a part of hardware of the vehicle 10 and transmitting data related to the status of the hardware to the integrated ECU 200. The control program 306 may have a function of controlling a part of the hardware of the vehicle 10.

The processor 301 is, for example, a CPU. However, the processor 301 is not limited to a CPU. The processor 301 may alternatively be a GPU. The processor 301 may be, for example, an ASIC or a programmable logic device such as a gate array or an FPGA. In this case, the ASIC or the programmable logic device can perform the same processing as the control program 306.

The communication I/F 304 is, for example, a CAN interface. The communication I/F 304 is connected to the integrated ECU 200 and the other individual ECUs 300 via a communication bus. The communication I/F 304 enables the individual ECU 300 to communicate with the integrated ECU 200.

The I/O 305 is connected to the sensors 400. The I/O 305 receives sensor data output the from the sensors 400. The I/O 305 may also be connected to an actuator provided in the vehicle 10. The I/O 305 can output a control signal to the actuator.

The individual ECU 300 transmits data with common specifications to the integrated ECU 200 even if hardware is different depending on the vehicle. For example, even if the specifications of the temperature sensor that measures the temperature of each tire are different between a vehicle A and a vehicle B, the individual ECU 300 processes sensor data of the temperature sensor and generates data with the same specifications (hereinafter referred to as “processed data”). The individual ECU 300 transmits the generated processed data to the integrated ECU 200. As a specific example, a case is described where the sampling rate of the temperature sensor of the vehicle A is different from the sampling rate of the temperature sensor of the vehicle B. The individual ECU 300 installed in the vehicle A performs processing such as calculating a moving average value or a moving median value of the sensor data output from the temperature sensor, and generates processed data. The individual ECU 300 installed in the vehicle A transmits the processed data to the integrated ECU 200 at predetermined time intervals. The individual ECU 300 installed in the vehicle B also performs processing such as calculating a moving average value or a moving median value of the sensor data output from the temperature sensor, and generates processed data. The individual ECU 300 installed in the vehicle B transmits the processed data to the integrated ECU 200 at the same time intervals as the time intervals at which the individual ECU 300 installed in the vehicle A transmits the processed data.

Further, even if the actuator is different between the vehicles, the individual ECU 300 receives a command with common specifications from the integrated ECU 200, and generates a control signal adapted to the actuator connected to the individual ECU 300 based on the command. The individual ECU 300 outputs the generated control signal to the actuator and controls the actuator. As a specific example, a case is described where a motor for each power window of the vehicle A is different from a motor for each power window of the vehicle B. The individual ECU 300 installed in the vehicle A generates a control signal conforming to the specifications of the motor installed in the vehicle A, based on the command received from the integrated ECU 200. The individual ECU 300 installed in the vehicle A outputs the generated control signal to the motor and controls the power window. The integrated ECU 200 transmits, to the individual ECU 300 installed in the vehicle B, the same command as that transmitted to the individual ECU 300 installed in the vehicle A. The individual ECU 300 installed in the vehicle B generates a control signal conforming to the specifications of the motor installed in the vehicle B, based on the received command. The individual ECU 300 installed in the vehicle B outputs the generated control signal to the motor and controls each power window.

### Functions of Integrated ECU

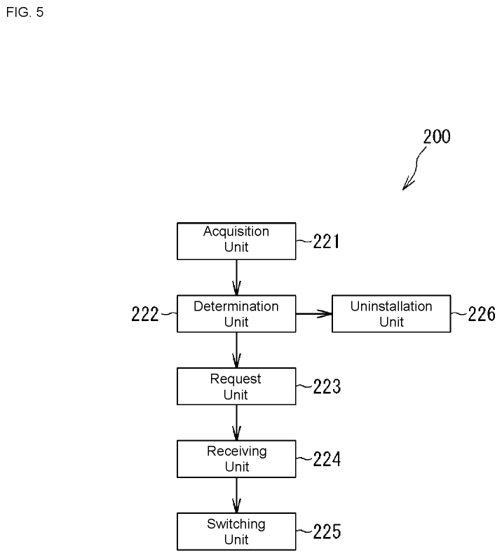

FIG. 5 is a functional block diagram showing an example of functionality of the integrated ECU according to the present embodiment.

The processor 201 realizes functions of an acquisition unit 221, a determination unit 222, a request unit 223, a receiving unit 224, a switching unit 225, and an uninstallation unit 226 by executing the control program 209.

The acquisition unit 221 acquires status information regarding the status of the vehicle 10. The status information may include information regarding the status of hardware detected by each sensor 400.

The individual ECU 300 accepts sensor data output from each sensor 400 and performs predetermined processing on the sensor data. For example, the individual ECU 300 processes a detection value of the sensor 400 and generates the processed data. The processed data is an example of information regarding the status of hardware.

The type of hardware installed in the vehicle is an example of the status of the vehicle 10. As a specific example, a case is described where a sensor 400 is an RFID reader, and an RF tag with information regarding a tire written is embedded in the tire. Information indicating a summer tire is written in an RF tag of a summer tire, and information indicating a studless tire is written in an RF tag of a studless tire. The sensor 400 reads the information from the RF tag of the tire of the vehicle 10, and the individual ECU 300 transmits that information (or information obtained by processing that information) to the integrated ECU 200. The information indicating a studless tire that is read from the RF tag indicates the status of the vehicle 10 in which the vehicle 10 is equipped with a studless tire.

The status information may include information indicating predicted future usage status of hardware. For example, the acquisition unit 221 can predict the future usage status based on usage history of the hardware of the vehicle 10. As a specific example, prediction of the future usage status of each tire is described. A sensor 400 detects the attachment and detachment of each tire to and from the vehicle 10. If the sensor 400 detects replacement of a tire, the individual ECU 300 transmits, to the integrated ECU 200, status information indicating the status of the vehicle 10 in which the tire has been replaced. The integrated ECU 200 manages the elapsed time since the previous tire replacement and estimates the timing when each tire will need to be replaced next time. The acquisition unit 221 acquires the estimated next tire replacement timing as information regarding predicted future usage status.

The status information may include information regarding environmental status around the vehicle 10 (hereinafter referred to as “environmental status information”). The environmental status information may include, for example, position information regarding the vehicle 10, meteorological information indicating the weather at the point where the vehicle 10 is located, meteorological forecast information at the point where the vehicle 10 is located, temperature information indicating the temperature at the point where the vehicle 10 is located, or the like. The acquisition unit 221 can receive the environmental status information from the server 50.

The determination unit 222 determines, based on the status information, whether or not to switch the software to be executed from the simplified software 210 to the detailed software 211.

For example, the determination unit 222 can determine, using information indicating the status of hardware, whether or not to switch the software to be executed from the simplified software 210 to the detailed software 211.

### Example 1

This is an example of the determination as to whether to switch software for tire replacement. In this example, the status information includes information indicating the air pressure of each tire. For example, a sensor 400 is an air pressure sensor that measures the air pressure of a tire. The individual ECU 300 processes sensor data output from the sensor 400, and can determine whether or not it is time for the tire to be replaced. For example, the timing when a tire needs to be replaced is when the air pressure is less than 80% for a tire of a company A, and is when the air pressure is less than 60% and the rate of decrease in air pressure over time is less than a specific value for a tire of a company B. Thus, the nominal value of the timing of tire replacement is different depending on the manufacturer, but the individual ECU 300 handles such differences in the hardware. That is, the individual ECU 300 applies the air pressure of the sensor data to the nominal value of the tire manufacturer, and determines whether or not it is time for the tire to be replaced. The individual ECU 300 transmits, as the status information, the result of determining whether it is time for the tire to be replaced to the integrated ECU 200. The determination unit 222 determines whether or not to switch the software to be executed from the simplified software 210 to the detailed software 211, using the result of determining whether it is time for the tire to be replaced. If the timing when the tire needs to replaced has arrived, the determination unit 222 determines that the software to be executed is switched from the simplified software 210 to the detailed software 211 in order to provide the user with detailed information regarding tire replacement. If the timing when the tire needs to be replaced has not arrived, the determination unit 222 determines that the software to be executed is not switched from the simplified software 210 to the detailed software 211.

### Example 2

This is another example of the determination as to whether to switch software for tire replacement. In this example, the number of years of use since each tire was installed (A1), the traveled distance since each tire was installed (A2), and the past usage status of the vehicle (user's driving history) (A3) are used as the status information used for the determination. A certain user drives the vehicle 10 three kilometers on weekdays to commute and return home, and drives the vehicle 10 four kilometers on weekends to go shopping. In this case, the distance traveled by the vehicle 10 in one month is 3 (km)×23 (days)+4 (km)×6 (days)=93 (km). The calculation result is used as A3. The determination unit 222 calculates the following equation (1).

$$A = A 1 \times a + A 2 \times b + A 3 \times c \qquad ( 1 )$$

a, b, and c are weight coefficients. The determination unit 222 compares the calculation result A of the above equation with a threshold N, and determines whether or not to switch the software to be executed from the simplified software 210 to the detailed software 211. The tires need to be replaced if A is greater than N. In this case, the determination unit 222 determines that the software to be executed is switched from the simplified software 210 to the detailed software 211 in order to provide the user with detailed information regarding the tire replacement. If A is smaller than or equal to N, the determination unit 222 determines that the software to be executed is not switched from the simplified software 210 to the detailed software 211.

### Example 3

This is yet another example of the determination as to whether to switch software for tire replacement. In this example, the number of years of use since each tire was installed (A1), the traveled distance since each tire was installed (A2), and the future usage status of the vehicle (user's driving schedule) (B3) are used as the status information used for the determination. B3 is the distance of long-distance travel (e.g. 100 kilometers or more) of the vehicle 10 scheduled up to one month ahead. The determination unit 222 determines whether or not to switch the software to be executed from the simplified software 210 to the detailed software 211, using the following four conditions.
Condition 3-1: A1×B3 is greater than or equal to a threshold N1.
Condition 3-2: A2×B3 is greater than or equal to a threshold N2.
Condition 3-3: A1 is 80% or more of a catalog value of usable years of the tires.
Condition 3-4: A2 is 80% or more of a catalog value of the travelable distance of the tires.

If at least one of the conditions 3-1, 3-2, 3-3, and 3-4 holds, the determination unit 222 determines that the software to be executed is switched from the simplified software 210 to the detailed software 211 in order to provide the user with detailed information regarding tire replacement. If none of the conditions 3-1, 3-2, 3-3, and 3-4 holds, the determination unit 222 determines that the software to be executed is not switched from the simplified software 210 to the detailed software 211.

### Example 4

This is an example of the determination as to whether to switch software for replacement with studless tires. In this example, the status information includes information indicating whether or not there is currently snow cover (C1), information indicating whether or not the vehicle 10 is currently wearing studless tires (C2), information indicating whether or not at least a certain amount of snow accumulation is forecast for the next two weeks (C3), date (C4), temperature (C5), and weather (C6).

C4 is, for example, a priority assigned to each number of days from the present. For example, priorities are assigned as follows: one day later: 99(%); two days later: 96(%); three days later: 92(%); four days later: 90(%); . . . , 10 days later: 60(%); 11 days later: 57(%); . . . .

C5 is, for example, a priority assigned to each lowest temperature in meteorological forecast. For example, priorities are assigned as follows: lower than −10° C.: 99(%); −10° C. or higher and lower than −5° C.: 90(%); −5° C. or higher and lower than 0° C.: 85(%); 0° C. or higher and lower than 3° C.: 80(%); 3° C. or higher and lower than 5° C.: 65(%); 5° C. or higher and lower than 8° C.: 50(%); 8° C. or higher: 0(%); . . . .

C6 is, for example, a priority assigned to each type of weather in meteorological forecast. For example, priorities are assigned as follows: rain: 70(%); sunny: 50(%); light snow: 85(%); snow: 90(%); and heavy snow: 100(%).

The determination unit 222 determines whether or not to switch the software to be executed from the simplified software 210 to the detailed software 211, using the following four conditions.
Condition 4-1: C1 is YES and C2 is YES;
Condition 4-2: C2 is YES and C3 is YES;
Condition 4-3: C2 is YES and C4×C5 is greater than or equal to a threshold N3; and
Condition 4-4: C2 is YES and C4×C6 is greater than or equal to a threshold N4.

If any one of the conditions 4-1, 4-2, 4-3, and 4-4 holds, the determination unit 222 determines that the software to be executed is switched from the simplified software 210 to the detailed software 211 in order to provide the user with detailed information regarding the replacement with studless tires. If none of the conditions 4-1, 4-2, 4-3 and 4-4 holds, the determination unit 222 determines that the software to be executed is not switched from the simplified software 210 to the detailed software 211.

In this example, the status information can also include snowfall status (C7) of an entire year (e.g. last year). C7 is, for example, a priority assigned to each month. For example, priorities are assigned for a city A as follows: November: 30%; December: 60%; January: 60%; February: 80%; March: 80%; and others: 0%. For example, priorities are assigned for a city B as follows: October: 10%; November: 90%; December: 90%; January: 70%; February: 70%; and others: 0%. For example, in the condition 4-3, “C4×C5 is greater than or equal to the threshold N3” can be replaced with “C4×C5×C7 is greater than or equal to the threshold N3”. In the condition 4-4, “C4×C6 is greater than or equal to the threshold N4” can be replaced with “C4×C6×C7 is greater than or equal to the threshold N4”.

The determination unit 222 can determine whether or not to switch the software to be executed from the simplified software 210 to the detailed software 211, based on a priority assigned to each type of the detailed software 211. Information provided to the user by the detailed software 211 includes highly important information regarding danger for the user, accidents of the vehicle 10, or the like, and information that is useful but less important. For example, information for notifying the user of abnormal air pressure of a tire and information for notifying the user that replacement with studless tires is necessary is highly important, while traffic congestion information is less important. A priority may be assigned to each type of the detailed software 211 depending on information that the user is notified of. For example, a “high” priority is assigned to a type of the detailed software 211 for notifying the user of abnormal air pressure of a tire and detailed software 211 for notifying the user that replacement with studless tires is necessary, while a “low” priority is assigned to a type of the detailed software 211 for providing the user with traffic information. The determination unit 222 can determine whether to switch to the software by combining the status information with the priority of the detailed software 211.

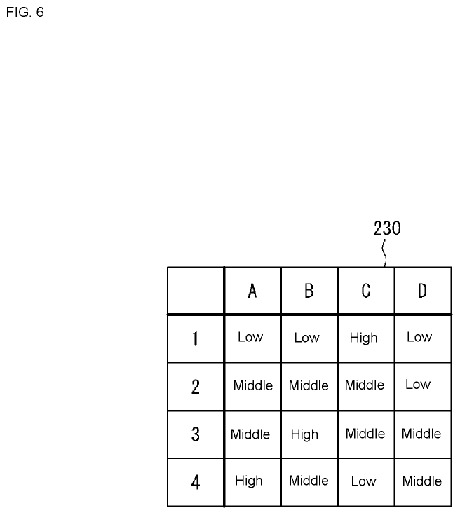

Priorities may be associated with the types of the detailed software 211 and the types of the environmental status around the vehicle 10. For example, the determination unit 222 can use a priority table that indicates the correspondence relationship between the type of the detailed software 211 and the type of the environmental status around the vehicle 10. FIG. 6 shows an example of the priority table. The rows of the table indicate the types of the detailed software 211 (A, B, C, D), and the columns of the table indicate the types of the environmental status (1, 2, 3, 4). In a priority table 230, a priority is assigned to each combination of the types A, B, C, and D of the detailed software 211 and the types of the environmental status 1, 2, 3, and 4. The determination unit 222 specifies the type of the detailed software 211 and the type of the environmental state that are to be subjected to switching determination, and determines priorities by referencing the priority table 230. The priority table 230 is stored in the nonvolatile memory 202.

The determination unit 222 may determine that the software to be executed is switched from the simplified software 210 to the detailed software 211 if the user gives the determination unit 222 an instruction to switch the software to be executed from the simplified software 210 to the detailed software 211. For example, if, in the above example 1, the time for the tires to be replaced has arrived, the determination unit 222 may cause the display device 250 to display a screen (e.g. a screen including buttons for instructions) on which the user can input an instruction to switch the software to be executed from the simplified software 210 to the detailed software 211, in order to provide detailed information for tire replacement. If the user inputs, through this screen, an instruction to switch the software to be executed from the simplified software 210 to the detailed software 211 to the input device 260 connected to the integrated ECU 200, the determination unit 222 can determine that the software to be executed is switched from the simplified software 210 to the detailed software 211. If the user does not input the aforementioned instruction to the integrated ECU 200, the determination unit 222 can determine that the software to be executed is not switched from the simplified software 210 to the detailed software 211.

Returning to FIG. 5, the status information may include information regarding communication status of the external communication device 500. If the communication status of the external communication device 500 is good, the integrated ECU 200 can access the database 40 and the server 50. If the communication status of the external communication device 500 is poor, it is difficult for the integrated ECU 200 to access the database 40 and the server 50. Thus, the communication status of the external communication device 500 indicates one state of the vehicle 10. Information regarding the communication status of the external communication device 500 is, for example, RSSI (Received Signal Strength Indicator). For example, the determination unit 222 can compare the RSSI with a threshold to determines whether or not to switch the software to be executed from the simplified software 210 to the detailed software 211. If, for example, the RSSI is greater than or equal to the threshold, the determination unit 222 can determine that the software to be executed is switched from the simplified software 210 to the detailed software 211. If, for example, the RSSI is smaller than the threshold, the determination unit 222 can determine that the software to be executed is not switched from the simplified software 210 to the detailed software 211. Further, if the RSSI is smaller than the threshold, the determination unit 222 can suspend download of the installation data of the detailed software 211.

If the determination unit 222 determines that the software to be executed is switched from the simplified software 210 to the detailed software 211, the request unit 223 makes a request for download of the installation data of the detailed software 211, to the database 40.

The installation data of the detailed software 211 is downloaded from the database 40 in response to the request from the request unit 223. The receiving unit 224 receives the installation data of the detailed software 211.

The switching unit 225 installs the detailed software 211 in the nonvolatile memory 202 using the installation data downloaded from the database 40. The switching unit 225 switches the software to be executed from the simplified software 210 to the detailed software 211. For example, the switching unit 225 ends the simplified software 210 and starts the detailed software 211.

Information provided to the user by the simplified software 210 is text information. That is, the simplified software 210 causes the display device 250 to display text information. The information provided to the user by the detailed software 211 includes image information. That is, the detailed software 211 causes the display device to display information including image information.

The information provided to the user by the simplified software 210 is information indicating an abnormality of the hardware installed in the vehicle 10. For example, the information that is provided to the user by the simplified software 210 and indicates an abnormality of the hardware installed in the vehicle 10 is text information. The information provided to the user by the detailed software 211 includes information indicating an abnormality of the hardware installed in the vehicle 10 and information indicating a countermeasure against the abnormality. For example, the information that is provided to the user by the detailed software 211 and indicates an abnormality of the hardware installed in the vehicle 10 may be text information, image information, or sound information. The information indicating a countermeasure against the abnormality may also be text information, image information, or sound information.

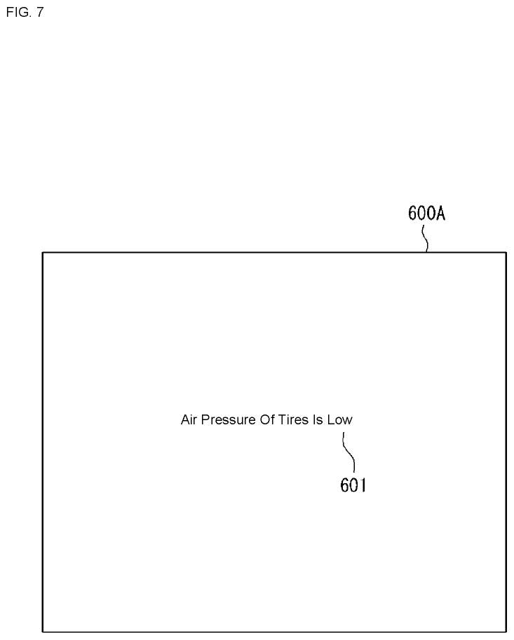

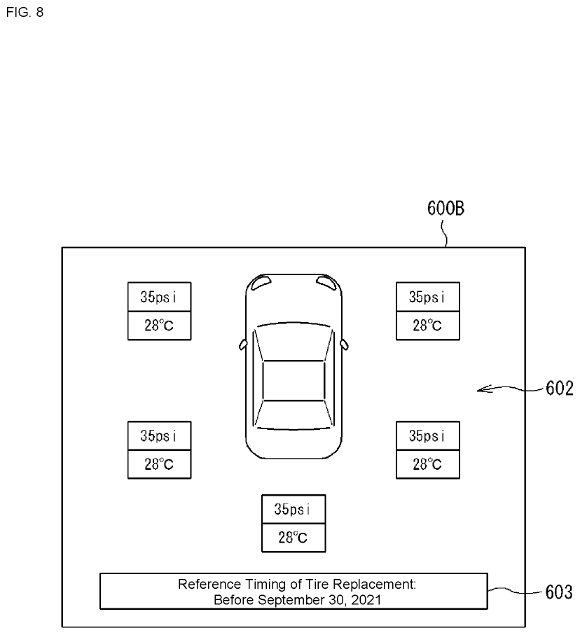

FIG. 7 shows an example of a display screen of the simplified software, and FIG. 8 shows an example of a display screen of the detailed software. The examples shown in FIGS. 7 and 8 are display screens of the simplified software 210 and the detailed software 211, respectively, for notifying the user of abnormal air pressure of the tires. If abnormal air pressure of any tire is detected, the simplified software 210 causes the display device 250 to display a display screen 600A. The display screen 600A includes text information 601. The text information 601 is information indicating an abnormality in a tire, with a message that “AIR PRESSURE OF TIRES IS LOW”.

Referring to FIG. 8, if abnormal air pressure of any tire is detected, the detailed software 211 causes the display device 250 to display a display screen 600B. The display screen 600B includes image information 602 and text information 603. The image information 602 includes a top view of the vehicle 10, and text information indicating the air pressures and temperatures of five tires including a spare tire. The image information 602 is information indicating the abnormality of the tires with numerical values. The text information 603 indicates a reference timing of tire replacement. The reference timing of tire replacement is an example of a countermeasure for solving the abnormal air pressure. As yet another example, the display screen 600B of the detailed software 211 may also include text information, image information, or a combination thereof that explains a method of air pressure adjustment work for the tires, and may also include a map or an address indicating the location of a store that provides air pressure adjustment work for the tires.

In addition to the aforementioned display screen 600B, the detailed software 211 may also output sound information to notify the user of abnormal air pressure of any tire from the speaker 270. Note that the detailed software 211 may alternatively cause the display device 250 to display the display screen 600B that includes image information, without causing the speaker 270 to output sound information. Also, the detailed software 211 may cause the speaker 270 to output sound information without causing the display device 250 to display the display screen 600B that includes the image information (e.g. may cause the display device 250 to display a display screen that includes text information regarding the abnormal air pressure of any tire and does not include image information).

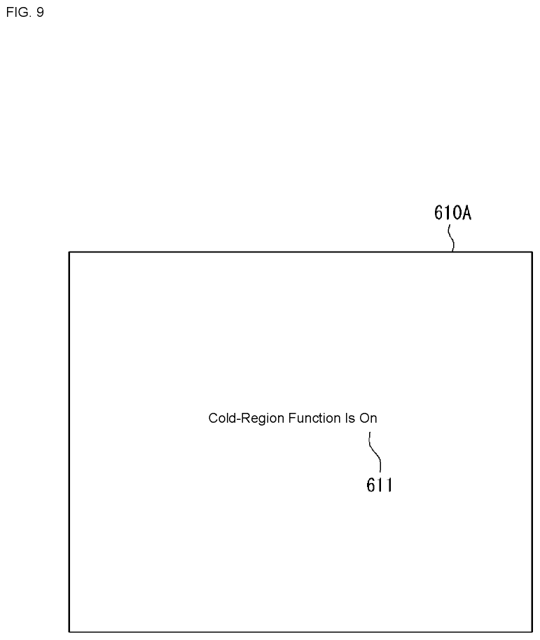

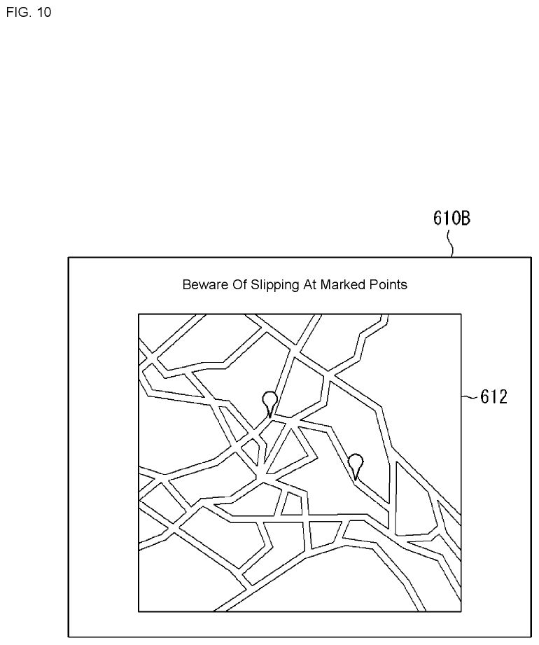

FIG. 9 shows another example of a display screen of the simplified software, and FIG. 10 shows another example of a display screen of the detailed software. The examples shown in FIGS. 9 and 10 are display screens of the simplified software 210 and the detailed software 211, respectively, for notifying the user of information necessary for the vehicle 10 to travel in cold regions. If it is determined that the vehicle 10 is in a cold region based on temperature, meteorological information, position information, or the like, the simplified software 210 causes the display device 250 to display a display screen 610A. The display screen 610A includes text information 611. The text information 611 is a message that “COLD-REGION FUNCTION IS ON”.

Referring to FIG. 10, if it is determined that the vehicle 10 is in a cold region, the detailed software 211 causes the display device 250 to display a display screen 610B. The display screen 610B includes image information 612. The image information 612 is a map showing locations where slip accidents are likely to occur. As yet another example, the display screen 610B of the detailed software 211 may also include information indicating whether or not studless tires are installed, information suggesting replacement with studless tires, text information, image information, or a combination thereof that illustrates a method for tire replacement work, information suggesting the concentration ratio of antifreeze, or the like.

In addition to the aforementioned display screen 610B, the detailed software 211 may output, from the speaker 270, sound information for notifying the user that replacement with studless tires is necessary, for example. Note that the detailed software 211 may cause the display device 250 to display the display screen 610B that includes image information without causing the speaker 270 to output sound information, or may cause the speaker 270 to output sound information without causing the display device 250 to display the display screen 610B that includes image information (e.g. may cause the display device 250 to display the text information that indicates that the cold-region function turned on and does not include image information).

Returning to FIG. 5, the uninstallation unit 226 uninstalls an unnecessary type of the detailed software 211 from the nonvolatile memory 202. For example, if the remaining capacity of the nonvolatile memory 202 is smaller than a reference value, some types of the installed detailed software 211 is uninstalled. The uninstallation target is selected based on the priority of the detailed software 211, for example.

### Operation of Individual ECU

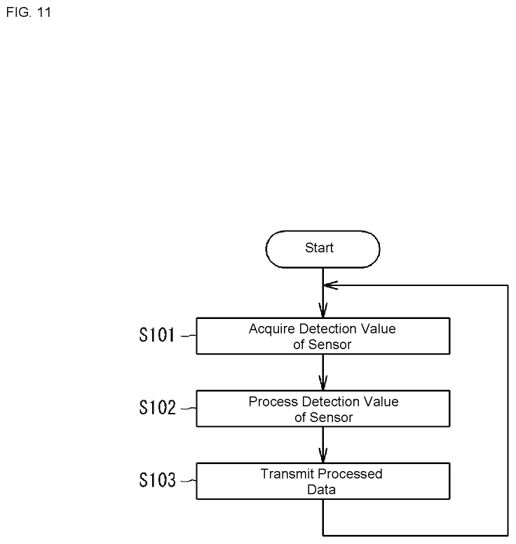

Operation of the in-vehicle system 100 according to the present embodiment is described below. The following data collection processing is performed by the processor 301 of the individual ECU 300 executing the control program 306. FIG. 11 is a flowchart showing an example of data collection processing performed by the individual ECU according to the present embodiment.

Each sensor 400 detects the status of hardware and outputs sensor data indicating a detection value. The individual ECU 300 acquires the sensor data output from the sensor 400 (step S101).

The processor 301 processes the sensor data and generates processed data (step S102). The processing is calculation of a moving average value, a moving median value, or the like of the detection value.

The processor 301 transmits the generated processed data to the integrated ECU 200 (step S103). Thereafter, the processor 301 returns to step S101. Thus, processed data is repeatedly generated and transmitted to the integrated ECU 200.

### Operation of Integrated ECU

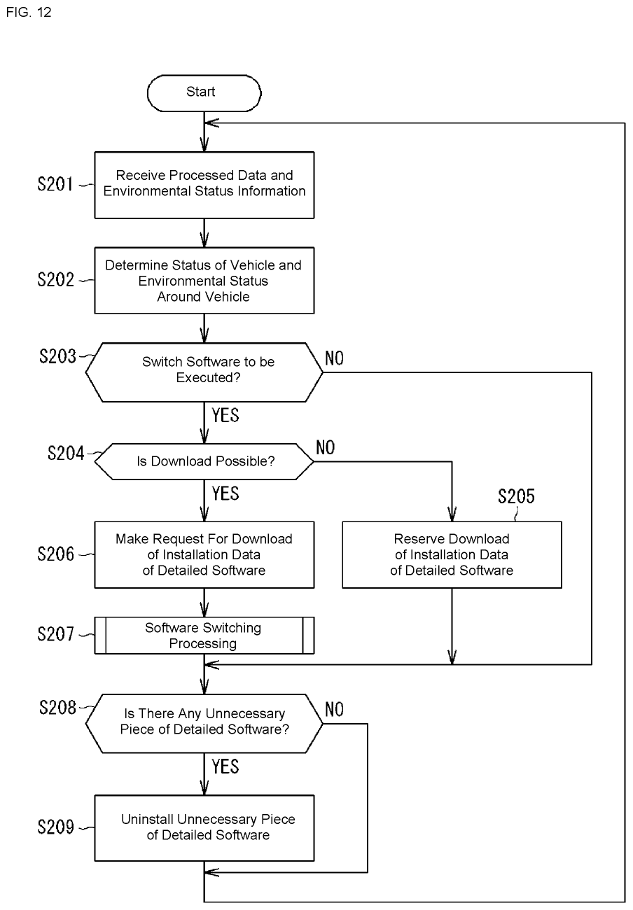

The following software switching determination processing is performed by the processor 201 of the integrated ECU 200 executing the control program 209. FIG. 12 is a flowchart showing an example of the software switching determination processing performed by the integrated ECU according to the present embodiment.

The individual ECU 300 transmits processed data, as mentioned above. Further, the integrated ECU 200 requests the server 50 to provide environmental status information, such as meteorological information, meteorological forecast information, and temperature information. The server 50 transmits the environmental status information in response to the request from the integrated ECU 200. The integrated ECU 200 receives the processed data and the environmental status information (step S201).

The processor 201 determines the status of the hardware installed in the vehicle 10 (whether or not the air pressure of each tire is insufficient, the type of the tires installed in the vehicle 10, etc.) and the environmental status around the vehicle 10 (current meteorological status, future meteorological status, current temperature, etc.), based on the processed data and the environmental status information (step S202).

The processor 201 determines whether or not to switch the software to be executed from the simplified software 210 to the detailed software 211 based on the determined status of the vehicle 10 (step S203).

If it is determined that the software is not switched (NO in step S203), the processor 201 proceeds to step S208.

If it is determined that the software is switched (YES in step S203), the processor 201 makes an inquiry about the communication status (RSSI) to the external communication device 500. The processor 201 determines, based on the RSSI, whether or not the installation data of the detailed software 211 can be downloaded (step S204).

If it is determined that the installation data of the detailed software 211 cannot be downloaded (NO in step S204), the processor 201 suspends download of the installation data of the detailed software 211 and reserves download of the installation data (step S205). After reserving download of the installation data, the processor 201 proceeds to step S208.

If it is determined that the installation data of the detailed software 211 can be downloaded (YES in step S204), the processor 201 makes a request for download of the installation data of the detailed software 211, to the database 40 (step S206).

After downloading the installation data, the processor 201 executes software switching processing (step S207).

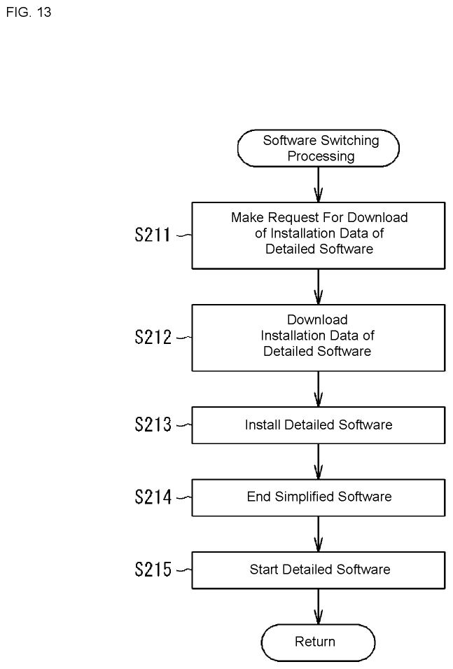

FIG. 13 is a flowchart showing an example of the software switching processing performed by the integrated ECU according to the present embodiment.

The processor 201 makes a request for the installation data of the detailed software 211 to the database 40 (step S211). The installation data of the detailed software 211 is downloaded from the database 40 in response to the request. The integrated ECU 200 receives the installation data (step S212).

The processor 201 installs the detailed software 211 in the nonvolatile memory 202 using the downloaded installation data (step S213).

After the installation of the detailed software 211 is complete, the processor 201 ends the simplified software 210 in execution (step S214). The processor 201 starts the installed detailed software 211 (step S215). The software switching processing ends here.

Returning to FIG. 12, the processor 201 proceeds to step S208 after ending the software switching processing.

In step S208, the processor 201 determines whether or not there is any unnecessary piece of detailed software 211 (step S208). For example, if the available capacity of the nonvolatile memory 202 is smaller than a predetermined reference value, it is determined that a piece of the detailed software 211 that is of lowest priority is unnecessary. In another example, if a piece of the detailed software 211 that is for notifying the user of an abnormality of the hardware of the vehicle 10 is being executed and the abnormality has already been solved, it is determined that this piece of detailed software 211 is unnecessary.

If there is any unnecessary piece of detailed software 211 (YES in step S208), the processor 201 uninstalls the unnecessary piece of detailed software 211 from the nonvolatile memory 202 (step S209). After uninstalling the detailed software, the processor 201 returns to step S201. The processor 201 also returns to step S201 when there is no unnecessary piece of detailed software 211 (NO in step S208).

### Variations

In the above embodiment, the integrated ECU 200 determines whether or not to switch the software to be executed from the simplified software to the detailed software, based on the status information regarding the status of the vehicle 10. However, this need not be the case. For example, in an in-vehicle system that includes a plurality of in-vehicle devices (ECUs) that have a function of controlling the hardware of the vehicle 10 or a function of providing the user with information, the plurality of in-vehicle devices may determine whether or not to switch the software to be executed from the simplified software to the detailed software based on the status information regarding the status of the vehicle 10.

In the above embodiment, the integrated ECU 200 and the individual ECUs 300 are connected by the CAN. However, this need not be the case. For example, the integrated ECU 200 and the individual ECUs 300 may alternatively be connected by Ethernet (registered trademark).

### Effects

The in-vehicle system 100 includes the integrated ECU 200 (first in-vehicle device), the individual ECUs 300 (second in-vehicle device), and the external communication device 500. The individual ECUs 300 can communicate with the integrated ECU 200. The external communication device 500 can communicate with the database 40 (external device) disposed outside the vehicle 10. The integrated ECU 200 includes the nonvolatile memory 202 (memory), the determination unit 222, the request unit 223, and the switching unit 225. The simplified software 210 (first software) is stored in the nonvolatile memory 202. The simplified software 210 is software for providing the user with simplified information (first information). The determination unit 222 determines whether or not to switch the software to be executed from the simplified software 210 to the detailed software 211 (second software), based on the status information regarding the status of the vehicle 10. The detailed software 211 is software for providing the user with detailed information (second information). If the determination unit 222 determines that the software to be executed is switched from the simplified software 210 to the detailed software 211, the request unit 223 makes a request for download of the detailed software, to the database 40 via the external communication device 500. The switching unit 225 installs, in the nonvolatile memory 202, the detailed software 211 downloaded from the database 40. The switching unit 225 switches the software to be executed from the simplified software 210 to the detailed software 211. The simplified software 210 is used when providing the user with simplified information. Thus, the capacity of the nonvolatile memory 202 and the volatile memory 203 of the integrated ECU 200 can be prevented from being squeezed. It is therefore possible to prevent an increase in the capacity of the memories installed in the integrated ECU 200. When providing the user with detailed information, the software to be executed is switched from the simplified software 210 to the detailed software 211. Accordingly, a variety of information can be provided to the user.

The individual ECU 300 may include sensors 400 that detect the status of the hardware installed in the vehicle 10. The status information may include information regarding the status of the hardware detected by each sensor 400. It is possible to determine whether or not to switch the software to be executed from the simplified software 210 to the detailed software 211, using the information acquired by the sensors 400. With this configuration, the detailed software for providing the user with detailed information for replacing or repairing the hardware can be executed if, for example, it is determined that the hardware needs to be replaced or repaired based on the status of the hardware detected by the sensors 400.

The status information may include information indicating predicted future usage status of the hardware installed in the vehicle 10. It can be determined whether or not to switch the software to be executed from the simplified software 210 to the detailed software 211 while considering the future usage status of the hardware installed in the vehicle 10. With this configuration, the detailed software 211 for providing the user with detailed information for replacing or repairing the hardware can be executed if, for example, it is determined that the hardware needs to be replaced or repaired based on the predicted future usage status of the hardware.

The status information may include information regarding the environmental status around the vehicle 10. It can be determined whether or not to switch the software to be executed from the simplified software 210 to the detailed software 211 while considering the environmental status around the vehicle 10. With this configuration, the detailed software 211 for providing the user with detailed information for replacing or repairing the hardware can be executed if, for example, it is determined that the hardware needs to be replaced or repaired based on the environmental status around the vehicle 10.

The determination unit 222 may determine whether or not to switch the software to be executed from the simplified software 210 to the detailed software 211 based on the priority assigned to the environmental status around the vehicle 10. For example, the software to be executed can be switched from the simplified software 210 to the detailed software 211 if the priority is higher than a reference.

The determination unit 222 may determine that the software to be executed is switched from the simplified software 210 to the detailed software 211 if the user gives an instruction to switch the software to be executed from the simplified software 210 to the detailed software 211. With this configuration, the software to be executed can be switched from the simplified software 210 to the detailed software 211 in accordance with the instruction from the user.

The determination unit 222 may determine whether or not to switch the software to be executed from the simplified software 210 to the detailed software 211, based on the priority assigned to the detailed software 211. The priority may be assigned to the detailed software 211 in accordance with the priority of information provided to the user by the detailed software 211. For example, the software to be executed can be switched from the simplified software 210 to the detailed software 211 if the priority is higher than a reference.

Priorities may be associated with the types of the detailed software 211 and the types of the environmental status around the vehicle 10. For example, the priority can be determined in accordance with the importance of the information provided to the user by the detailed software 211 and the severity of the environmental status around the vehicle 10.

The status information may include information regarding communication status of the external communication device 500. For example, the detailed software 211 can be downloaded if the communication status of the external communication device 500 is good, and download of the detailed software 211 can be avoided when the communication status of the external communication device 500 is poor.

Simplified information provided to the user by the simplified software 210 may be text information. Detailed information provided to the user by the detailed software 211 may include image information. The size of the simplified software 210 can be reduced by using simple text information as the simplified information. Detailed information in the form of images can be provided to the user by including image information in the detailed information.

Simplified information provided to the user by the simplified software 210 may be text information. Detailed information provided to the user by the detailed software 211 may include sound information. The size of the simplified software 210 can be reduced by using simple text information as the simplified information. Detailed information in the form of sound can be provided to the user by including sound information in the detailed information.

The simplified information may be information indicating an abnormality of the hardware installed in the vehicle 10. The detailed information may include information indicating an abnormality of the hardware installed in the vehicle 10 and information indicating a countermeasure against the abnormality. When the hardware is abnormal, the simplified software 210 can notify the user of the abnormality. Further, the size of the simplified software 210 can be reduced. The detailed software 211 can not only notify the user of the abnormality, but also present a countermeasure against the abnormality to the user.

### Supplementary Notes

An in-vehicle device to be installed in a vehicle, the device including: a sensor configured to detect status of hardware installed in the vehicle; and a transmission unit configured to transmit, to another in-vehicle device, information regarding the status of the hardware detected by the sensor, in order for the other in-vehicle device to determine whether or not to switch software to be executed from first software for providing a user with first information to second software for providing the user with second information that is more detailed than the first information.

A computer program for causing a computer, which includes a memory, to function as an in-vehicle device to be installed in a vehicle, the computer program causing the computer to function as: a determination unit configured to determine, based on status information regarding status of the vehicle, whether or not to switch software to be executed from first software for providing a user with first information to second software for providing the user with second information that is more detailed than the first information; a request unit configured to make a request for download of the second software to an external device disposed outside the vehicle if the determination unit determines that the software to be executed is switched from the first software to the second software; and a switching unit configured to install, in the memory, the second software downloaded from the external device and switch the software to be executed from the first software to the second software.

### Supplement

The embodiment disclosed herein is in all respects illustrative and not restrictive. The scope of rights of the present disclosure is defined not by the above-described embodiment but by the claims, and encompasses all changes made within the meanings and scope equivalent to the claims.

1. An in-vehicle system comprising:
a first in-vehicle device;
a second in-vehicle device capable of communicating with the first in-vehicle device; and
an external communication device capable of communicating with an external device disposed outside a vehicle,
the first in-vehicle device including:
a memory for storing first software for providing a user with first information;
a determination unit configured to determine whether or not to switch software to be executed from the first software to second software for providing the user with second information that is more detailed than the first information, based on status information regarding status of the vehicle;
a request unit configured to make a request for download of the second software to the external device via the external communication device if the determination unit determines that the software to be executed is switched from the first software to the second software; and
a switching unit configured to install, in the memory, the second software downloaded from the external device, and switch the software to be executed from the first software to the second software.

2. The in-vehicle system according to claim 1,
wherein the second in-vehicle device includes a sensor configured to detect status of hardware installed in the vehicle, and
the status information includes information regarding the status of the hardware detected by the sensor.

3. The in-vehicle system according to claim 1,
wherein the status information includes information regarding predicted future usage status of hardware installed in the vehicle.

4. The in-vehicle system according to claim 1,
wherein the status information includes information regarding environmental status around the vehicle.

5. The in-vehicle system according to claim 4,
wherein the determination unit determines whether or not to switch the software to be executed from the first software to the second software, based on a priority assigned to the environmental status around the vehicle.

6. The in-vehicle system according to claim 1,
wherein the determination unit determines that the software to be executed is switched from the first software to the second software if the user gives the determination unit an instruction to switch the software to be executed from the first software to the second software.

7. The in-vehicle system according to claim 1,
wherein the determination unit determines whether or not to switch the software to be executed from the first software to the second software, based on a priority assigned to the second software.

8. The in-vehicle system according to claim 7,
wherein a plurality of the priorities are each associated with a type of the second software and a type of environmental status around the vehicle.

9. The in-vehicle system according to claim 1,
wherein the status information includes information regarding communication status of the external communication device.

10. The in-vehicle system according to claim 1,
wherein the first information is text information, and
the second information includes image information.

11. The in-vehicle system according to claim 1,
wherein the first information is text information, and
the second information includes sound information.

12. The in-vehicle system according to claim 1,
wherein the first information is information indicating an abnormality of hardware installed in the vehicle, and
the second information includes the information indicating the abnormality of the hardware installed in the vehicle and information indicating a countermeasure against the abnormality.

13. An in-vehicle device to be installed in a vehicle, the device comprising:
a memory for storing first software for providing a user with first information;
a determination unit configured to determine whether or not to switch software to be executed from the first software to second software for providing the user with second information that is more detailed than the first information, based on status information regarding status of the vehicle;
a request unit configured to make a request for download of the second software to the external device disposed outside the vehicle if the determination unit determines that the software to be executed is switched from the first software to the second software; and
a switching unit configured to install, in the memory, the second software downloaded from the external device, and switch the software to be executed from the first software to the second software.

14. A software switching method for switching software incorporated in an in-vehicle device to be installed in a vehicle, the method comprising:
a step of determining whether or not to switch software to be executed from first software for providing a user with first information to second software for providing the user with second information that is more detailed than the first information, based on status information regarding status of the vehicle;
a step of making a request for download of the second software to the external device disposed outside the vehicle if it is determined that the software to be executed is switched from the first software to the second software; and
a step of installing, in a memory included in the in-vehicle device, the second software downloaded from the external device, and switching the software to be executed from the first software to the second software.
